(19) United States
(12) Patent Application Publication
(10) Pub. No.: US 2009/0214019 A1
(43) Pub. Date: Aug. 27, 2009

(54) Communication server with paralell telopnone dialing capability

(76) Inventors: Philip Lee Brooks, Sunnyvale, CA (US); Eric Tyler Minkles Brooks, Portland, OR (US); Dominique Trempont, Menlo Park, CA (US)

Correspondence Address: Phil Brooks, 747 Lakefair Drive, Sunnyvale, CA, 94089, US

(21) Appl. No.: 12/072,650

(22) Filed: Feb. 27, 2008

(51) Int. Cl. H04M 3/00

(52) U.S. Cl. 379/243

(57) ABSTRACT

A System for communicating between Remote Sentry Devices (conveniently called Enabled Cell-Phones or Enabled Wireless Devices) and members of a community (End-Users) or with other Remote Sentry Devices through a Central Point Server in order to provide a multiplicity of communication paths and access to Applications Program content by means of said Central Point Server. Said Central Point Server may contain or have access-to a multiplicity of Applications Programs which may be engaged in order to execute pre-determined scenarios or to enhance pre-determined scenarios in response to input from Enabled Wireless Devices or other End-User Devices. Said Central Point Server could be the enabler for, as an illustrative example, the Stealth Mode capabilities of referenced Enabled Wireless Devices. Said Central Point Server could also dynamically manage various scenarios in response to unfolding events as communicated by said Enabled Wireless Devices or End-Users.

### CROSS REFERENCE TO RELATED APPLICATIONS

Provisional Patent Applications U.S. 60/775,389 (Leave-behind remote sentry device); U.S. 60/802,886 (Additions to Leave-behind remote sentry device); U.S. 60/818,169 (Community Communication System with Stealth Mode); Provisional Patent Application U.S. 60/831,290 (Communication Server with Parallel Telephone Dialing Capability); and Utility U.S. patent appliation Ser. No. 11/708,100 (Leave-Behind Sentry with Community Communications and Stealth Mode) are related applications.

The Provisional Patent Application U.S. 60/831,290 (Communication Server with Parallel Telephone Dialing Capability) is the Provisional Patent Application that directly relates to this Utility Patent Application.

### FEDERALLY SPONSORED RESEARCH

Not Applicable.

### SEQUENCE LISTING OR PROGRAM

Not Applicable.

### BACKGROUND OF THE INVENTION

1. Field of the Invention

Previously filed Provisional Patent Applications for a Leave-Behind Remote Sentry Device, U.S. 60/775,389 filed Feb. 21, 2006; followed by U.S. 60/802,886 filed May 22, 2006; U.S. 60/818,169, a Community Communication System with Stealth Mode filed Jun. 29, 2006; U.S. 60/831,290, Communication Server with Parallel Telephone Dialing Capability filed Jul. 17, 2006, and finally, the Utility patent U.S. Ser. No. 11/708,100, filed Feb. 21, 2007; all relate directly to this application. The preferred embodiment of both inventions is a cell-phone or similar wireless-enabled mobile communication device.

U.S. 60/775,389, U.S. 60/802,886, U.S. 60/818,169, U.S. Ser. No. 11/708,100 all anticipate the use of an intermediate “central point” (typically manned such as by a Security Person) in their use-scenarios, but refer to not having a (typically) manned central point as being an advantage to both the cost and the spontaneity of the use of (1) and (2) above.

Provisional Patent Application U.S. 60/831,290 (Communication Server with Parallel Telephone Dialing Capability) is a separate invention and describes the employment of a ° Central Point Server or System”, said Central Point Server or System being a great advantage over existing (typically) manned central points (which may or may not involve a Central Point Server or System). The first prior invention, Utility Patent Application U.S. Ser. No. 11/708,100 (Leave-Behind Sentry with Community Communications and Stealth Mode) describes a Leave-Behind Remote Sentry Device above, may be described as “I'm There”—meaning that the End-User of the device described is either not at the location of an event to which said End-User is being alerted-to, or may be at the location of said event, but is not aware of said event until notified by said device—thus enabling the End-User to be virtually “there”. U.S. Ser. No. 11/708,100 also describes what may be characterized as “I'm Here”—where the End-User is at the location of an event and needs to inform others regarding the location, nature, or both, of said event. U.S. Ser. No. 11/708,100 also provides for the ability of a first enabled device (cell-phone, internet-phone, telephony-enabled laptop and the like) to turn-on the speaker of a second called enabled device (or a multiplicity of enabled devices) and listen to the environment the called-device is in without any action being taken by the user of said second device. This is conveniently termed “stealth mode”. Wide variations to these scenarios are included in the descriptions of those inventions. However, what happens if several events occur at the same, or at nearly the same real time? Those concerns, and others, comprise un-served needs that the present Utility Patent Application addresses.

2. Prior Art

Presently, remote alarm systems typically have had to communicate through a central-point system or an extremely limited “direct to owner (or central point service)” in an economically deficient manner (for example, the monthly service charges are excessive, and a human being typically must be present at the central-point creating wage and infrastructure costs) and also a technically deficient manner (for example, must use a land-(telephone) line, may only be able to “dial” one number (or one number at a time, may only be able to connect wirelessly a few meters), and many other deficiencies both economic and technical such as, for example, loss of land-line connection, having “the number called” not answer, having a very short “wireless” capability that still must connect to a land-line, and multiple inputs may overwhelm the capabilities of the system. All are major present issues.

### OBJECTS AND ADVANTAGES

Accordingly, several objects and advantages of the invention are in serving the following unmet needs:

A first un-met need exists for providing more computing power (the ability to process multiple events simultaneously and in a multiplicity of “mixes”) and more memory (to manage/execute a multiplicity of events; different call lists based on the input received; and a multiplicity of messages related to each event and call lists) than is provided by mobile, wireless, two-way voice/non-voice communication-capable devices such as, for example, existing cell-phones and “phones” (such as Personal Digital Assistants, and Blackberry-Devices and the like) without the added expense and “real-time-lag” and “second-guessing the intent of the End-User) inherent in the present manned-central-points as is the current convention.

While a great many solutions exist for members of a community (group) to communicate with each other, there presently exists no system for quickly executing a telephone list of community members (a telephone-call-list) with a voice message “all at once” (or without a message—the message simply being “the calling number” being recognized by said community members as “the message”); delivered to said list without the first person (the person initiating a call that engages a stored list of community members) manually dialing each members phone number in sequence. One-touch “speed” dialing (whereby the person depresses typically one key) or voice actuated dialing (whereby the person says typically one word to initiate a single call) are both examples of manual dialing versus a system or device that simultaneously calls a list of numbers without further intervention by the first person other than said first person having initiated “calling the list”. Such initiation may be by One-Touch dialing, Spoken-Word, or a pre-set tone; all of which being presently widely known and used. What is needed is a system that can call, as in “dial telephone numbers”—a list “all at once” or very nearly all at once. Using just one current and obvious illustrative example: when a Universities Administration needs to notify all teachers and all students in very nearly real-time that a dangerous person or event is taking place or is about to take place.

The present invention addresses a first unique fact that the “all-at-once contact numbers” may be a multiplicity of ordinary telephone numbers, and not just a single telephone number or Email address. A second unique fact is that said Central Point Server or System may be “triggered into the dialing sequence” with the initiating “trigger” received by the Central Point Server or System being voice, an SMS message, or even an Email. (Initiating a dialing sequence by means of a communications port in a central-point computer (or other system) is well-known; however the input to the central point is not an email or voice command coming by means of the Internet.) Subsequent to said trigger, the Central Point Server or System may send a voice message to a list, an SMS or MMS. In fact, in certain anticipated applications, said SMS message may eventually be a preferred embodiment. The present inventions makes maximum use of the fact that the generation of a fast, clear and precise voice message is much faster than composing a clearly understood and precise text message. Short Messaging Service (SMS), conveniently described as text messages, or Multimedia Messaging Service (MMS) photographs and the like, sent over Email, and even “plain ordinary Email” can presently reach a list “all at once” as provided by the technology enabled in any present-technology Email-group (list). SMS requires typing-in a message to be sent, and said message, if composed in an urgent situation, may exhibit a multiplicity of the well-known concerns regarding Email messages in general, for example, inaccuracies, typing errors, deficient context, misunderstood “tone” or “tenor”. Even sending photographs without text for clarification may lead to the same lack of full and complete understanding as posed by text alone by the recipient. However, the present invention recognizes the use of stored SMS and MMS messages as presently being the fastest way to reach a group; however the “spontaneity and clarity aspects of the present message” of voice is lost. Nothing existing or anticipated in SMS and MMS is in conflict with this invention.

It is well understood and well-documented that voice communication is the fastest method to assure complete understanding of a message at the recipient-end, especially if the message is composed in haste or in an environment of great fear or danger.

Regarding spontaneity with regard to voice messages, the immediate implication is for mobility. Spontaneity at one's desk is easily served by a multiplicity of well known devices and systems (including having assistants dial the numbers on the list), but spontaneity while on-the-move requires a purely mobile initiating device or a system in which mobility is not encumbered (such as by a Central Point Server or System or system).

The present invention is able to receive a multiplicity of inputs regarding events and their associated subsequent actions “all at once” or very nearly all at once. The issue being spontaneity and speed,

A second un-met need exists therefore for a Central Point Server or System solution that has the end-user configurable ability to contact different prioritized lists of ultimate responders, deliver spontaneous messages, listen, capture/transmit digital images, enable two-way conversation or signals, and engage (work with) the higher-level attributes of advanced wireless networks such as Global Positioning Systems and Client initiated Location Tracking; and advanced wireless devices such as phones—thus taking advantage of all of the aspects referred-to in said two previous Provisional Patent Applications

A third un-met need also relates to spontaneity and speed—said Central Point Server or System would advantageously employ voice-recognition software so that a trigger instruction may be transmitted to the server from either an enabled device as previously described in said two previous Provisional Patent Applications, or non-enabled devices which are in the form of voice.

A fourth un-met need also relates to spontaneity and speed—said Central Point Server or System would advantageously be able to receive an instruction transmitted to said Central Point Server or System from either an enabled device as previously described in said Utility patent application U.S. Ser. No. 11/708,100, or from non-enabled devices which are capable of transmitting trigger instructions in the form of SMS or Email.

A fifth un-met need is for a Central Point Server or System employing the advantages described above, that can be triggered into action by a signal from a “non-enabled” (referring to U.S. Ser. No. 11/708,100) device such as, for illustrative example, an ordinary telephone.

A sixth un-met need relates again to spontaneity and speed—for said Central Point Server or System to be able to connect to other Central Point Servers or Systems so that an instruction may be transmitted to “the first available” Central Point Server or System or to a selected Central Point Server or System; and further, to allow said Central Point Servers or Systems to communicate with each other, for illustrative example, when a server needs access-to or needs applications-from, a second (or more) Central Point Server or System.

The combinations of the un-met needs above are only limited by the imagination of the community members and the state of existing cell-phone/-phone and other telephony-enabled technology at the time, and are anticipated by the present invention.

### SUMMARY

All present solutions to urgent and dynamic communication scenarios are seriously handicapped by exhibiting one or more of the following serious limitations:
i. Central-Point Servers cannot dial-out a multiplicity of telephone numbers “all at once” or very nearly all at once”.
ii. Central-Point Servers cannot configure-ably and then automatically attach specified messages to said telephone call or multiplicity of telephone calls in response to end-user input.
iii. If voice messages are to be sent to a community (list) quickly, a human-staffed call-center or another human-assistant is required.
iv. Central-Point human-enhanced communication/interpretation if the call-list is generally required.
v. Central-Point Systems are handicapped by the use of hard-wired input means.

The present invention relates to U.S. Ser. No. 11/708,100 (Leave-Behind Sentry with Community Communications and Stealth Mode). U.S. Ser. No. 11/708,100 embodies three separate Provisional Patent Applications. The preferred embodiment of U.S. Ser. No. 11/708,100 is a cell-phone or similar wireless-enabled mobile communication device. Said first invention describes “alert voice messages” being transmitted to the End-User (said End-User being one or more of the persons on a call-list being called by an enabled wireless device) regarding “events” such as a power failure, medical condition, fire, flood, and the like.

Said first invention also describes how a first End-User can use said enabled devices to quickly configure a community (group) by means of preparing call-lists comprised of said community and “at the last minute” being able to record a voice message for immediate transmission; and how members of the community configure their own enabled devices to quickly receive said voice message and hang-up so the call-list-chain continues immediately. Another aspect of said second invention is how members” devices can be configured to answer-on-ring having said ring set to silent—thus enabling a “stealth-mode” of “call-pick-up” and having said End-User able to then silently and remotely turn-on the speaker of said member's enabled device and listen to said member's environment and if desired, begin a two-way conversation or down-load information such as maps—all the while in a stealth mode.

Said U.S. Ser. No. 11/708,100 anticipates the use of an intermediate “central point” (typically manned such as by a Security Person) in their use-scenarios. However, and importantly, both refer to not having a (typically) manned central point as being an advantage to both cost and spontaneity.

The present invention is for a Central-Point Server which overcomes the disadvantages cited in said first invention above. This Central Point Server or System can, among other advantages, dial-out a multiplicity of telephone numbers “all at once” or very nearly “all at once”. This is as opposed to the current system of having a human or other device dial-out a multiplicity of telephone numbers sequentially—meaning that only one telephone call can be “live and in-play” at a single time unless a multiplicity of calling devices are employed.

This is important because in urgent situations wherein, for illustrative example, a person or property/assets is at risk, speed is of the essence. Dialing one number at-a-time as is the limitation with all present voice-telephone calls, does not meet the “time (speed) is of the essence” criteria of urgent communication. It is also possible that there might be a simple convenience or business reason for being able to dial-out a multiplicity of telephone numbers “all at once” or very nearly “all at once”, for illustrative example in stock or commodities trading. Another preferred use of “all-at-once” is, for illustrative example, reaching a community (group) of people regarding location or information quickly, or even simply, more conveniently.

The process of the present invention is to use a “central point” computer (server) or group of computers, in ways neither suggested nor described in the current state of the art. The Central Point Server or System could be a computing device, for illustrative example laptop, palm-top, future (more powerful) personal digital assistants and “Blackberry” enabled devices and the like, desk-top computers or a computing device designed and configured as a server.

### DRAWINGS—FIGURES

FIG. 1: Central Point Server Overview

FIG. 2: An Event Occurs causing “Send”

FIG. 3: Sending a Response

### DESCRIPTION OF THE INVENTION

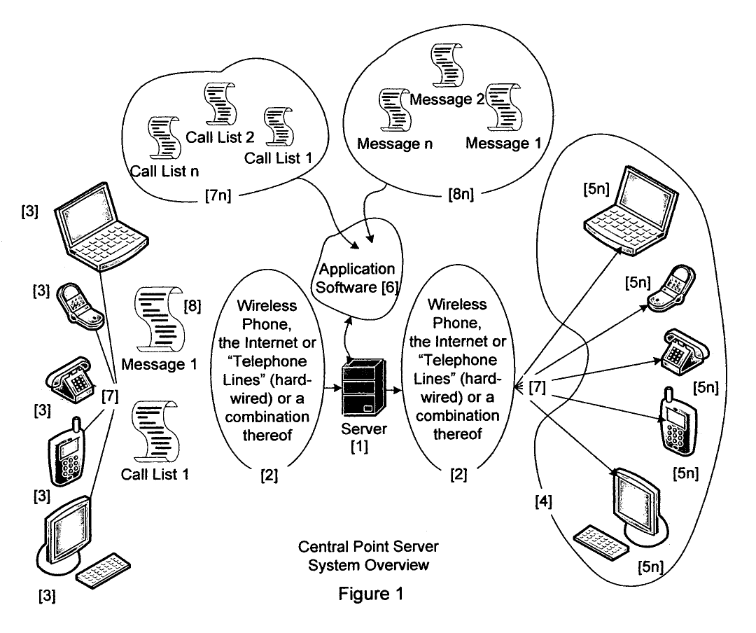

The clearest and most fundamentally illustrative example of the present invention is simply this: (Referring to FIG. 1): Assume a server (device) exhibiting the features and attributes of the Central Point Server or System or other device described above [1] being connected to a network (wireless, internet or hard-wired, or a combination of the above) [2]. You (the first person [3]) desire to communicate quickly (“all at once” versus sequentially) to a group (a community [4]) each of whom has access-to or in their possession a simple telephone, cell-phone, wireless enabled personal digital assistant or any other telephony-enabled device [5n] that can receive a telephone call. Said Central Point Server or System is enabled with the application software described herein [6]. You, as first person [3], have keyed-in or otherwise provided said Central Point Server or System with a Call List (Group List) [7] of telephone numbers [7n] in a manner such that said Central Point Server or System can locate said List(s) identified by number, name or other known means. Further, you, as first person [3], have provided said Central Point Server or System [1] with a voice message [8] or a multiplicity of voice messages [8n] that said Central Point Server or System has stored in memory in such a manner that said Central Point Server or System can locate said message(s) identified by number, name or other means.

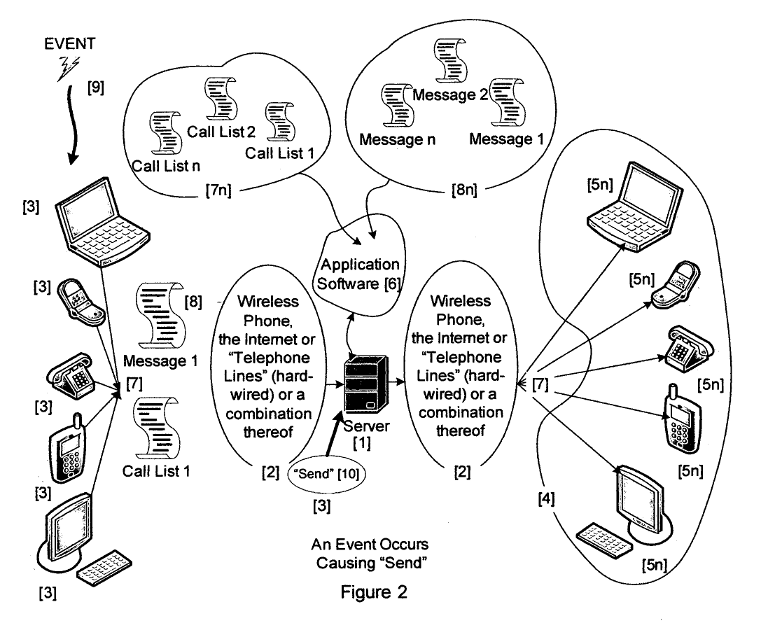

In this first illustrative example, FIG. 2, you [3] contact said Central Point Server or System [1] on account of an event/alert [9] having occurred (any said event/alert being such that time is of the essence—be it danger-driven, convenience or convenience-driven). You are desirous of causing said Central Point Server or System [1] to bring-up, by means of the application software described herein [71 a particular Call List [8] representing a single called-number [7] or group of called numbers [7n], and “attach” a particular Message [8] thereto. Said Central Point Server or System [1], when said list [8] is identified and said message [8] attached (ready to be attached), commences dialing said list [7] upon a trigger-signal (for example pressing “send”) [10] and delivering said message [8] to said called device [5] or called-devices [5n].

Clearly, text messages (SMS) and multi-media messages MMS) may be attached such that said called device may deliver the alert or message in a variety of ways as may best suit the called device.

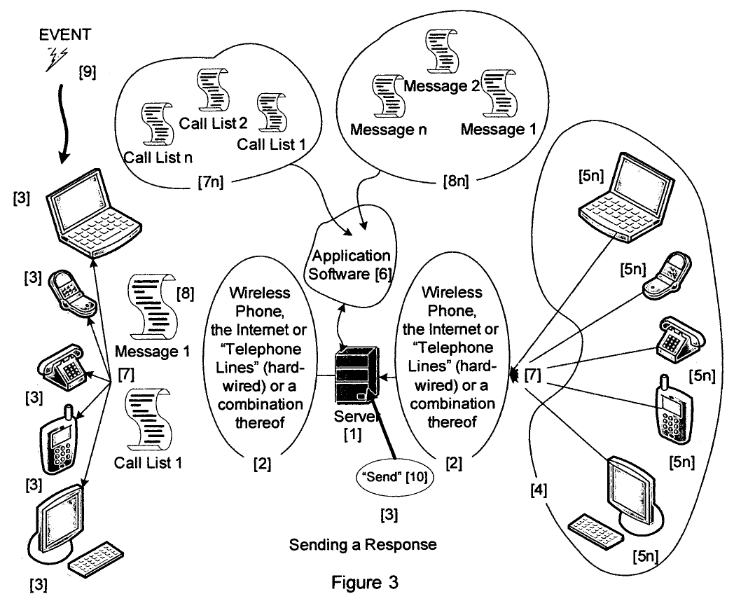

FIG. 3 depicts, in accordance with FIGS. 1 and 2 above, the unfolding scenario wherein a called member [7] of the community/call-list [7n] can “return the call” through said Central Point Server or System [1]. In this unfolding scenario, said called member [7] presses the keys secured for this purpose (configurable by the End-User) to initiate the Return Call sequence [10]. Said called member [8] may return the call to the originator [3], or to said entire Called-List [7] or to a different Call-List [7n]. Said Central Point Server or System [1], upon receiving the triggering signal [10], dials-out to an identified community member [8n], to the originator [2], to said entire Called-List [5] or to a different Call-List [10].

### CONCLUSION, RAMIFICATIONS, AND SCOPE

Accordingly, the reader will see that by the method and means of the present invention, I have provided a versatile wireless sensor with the capability of saving lives and property even when employed spontaneously. The implications for rescuing persons in dangerous situations, for locating persons in any situation, and for saving property through having the End-User in control (or sharing control) instead of relying on relatively static alarm systems is obvious and even intuitive. The freedom to simply leave-behind or pre-place a sensor with robust and even stealth wireless communication capability holds out the opportunity for both economic/personal safety and peace of mind.

The variety of situations in which the present invention might be employed are almost endless. While the above description contains many specificities, these should not be construed as limitations on the scope of the invention, but as illustrative examples of the presently referred embodiments thereof. Many other ramifications and variations are possible within the teachings of the invention, for example, integration of Global Positioning Systems and Streaming Video into the examples and scenarios herein.

Thus the scope of the invention should be determined by the appended claims and their legal equivalents, and not by the examples give.

1. A communication system comprising at least one Calling Device (“telephone” or any other telephony enabled device), one Answering Device (“telephone” or any other telephony enabled device), and one Central Point Server or System. Said calling and answering devices may or may not be related to t U.S. Ser. No. 11,708,100 (Leave-Behind Sentry with Community Communications and Stealth Mode).Said Central Point Server or System having the capability of dialing-out a single or a multiplicity of telephone numbers “all at once” or very nearly all at once, as opposed to sequential dialing.

2. The communication system of claim 1 wherein said Central Point Server or System has the capability of appending a recorded voice message to said dialed-out telephone calls.

3. The system of claim 1 comprising a plurality of said calling and said called-devices, said devices being enabled with the software described in U.S. Ser. No. 11/708,100 (Leave-Behind Sentry with Community Communications and Stealth Mode).—thereby forming a community of enabled devices.

4. The communication system of claim 3 further comprising means whereby said called-device may be configured to “Return-the-Call”.

5. The communication system of claim 4 further comprising means whereby said called-device may be configured to instruct said Central Server to “call-back” an identified community member, the originator, said entire Called-List, or to a different Call-List, said lists being stored in said Central Point Server or System.

6. A communication system in accordance with claim 3 wherein said Central Point Server or System can be instructed by said calling device or be pre-configured to send digital images to said called device.

7. A communication system in accordance with claim 3 wherein said Central Point Server or System can be instructed by said calling device or be pre-configured to instruct said called device to capture (take) digital images which said Central Point Server or System is able to capture.

8. A communication system in accordance with claim 3 wherein said Central Point Server or System can be instructed by said calling device or be pre-configured to instruct said Central Point Server or System is able to send said captured digital images to any member of said communication community or to a third party.

9. A communication system in accordance with claim 3 wherein said Central Point Server or System can be instructed by said calling device or be pre-configured to engage the Stealth-Mode described above in said called device.

10. A communication system in accordance with claim 3 whereby said Central Point Server or System would advantageously employ voice-recognition software so that a voice trigger instruction may be transmitted to said Central Point Server or System from either said enabled devices as previously described, or from non-enabled devices which are in the form of voice.

11. A communication system in accordance with claim 3 whereby said Central Point Server or System is able to connect to other Central Point Servers or Systems so that an instruction may be transmitted to “the first available” Central Point Server or System or to a selected Central Point Server or System; and further, to allow said Central Point Servers or Systems to communicate with each other, for illustrative example, when a server needs access-to or needs applications-from, a second (or more) Central Point Server or System.

12. A communication system in accordance with claim 3 whereby said Central Point Server or System is be able to receive an instruction transmitted to said Central Point Server or System from either an enabled device as previously described in said two previous Provisional Patent Applications, or from non-enabled devices which are capable of transmitting trigger instructions in the form of SMS or Email.
